(19) United States
(12) Patent Application Publication
(10) Pub. No.: US 2005/0214095 A1
(43) Pub. Date: Sep. 29, 2005

(54) Wall and ceiling fastening system and methods therefor

(76) Inventors: Brian A. Brown, Danville, CA (US); Gregory A. M. Brown, Walnut Creek, CA (US)

Correspondence Address: Brian A. Brown, 52 Rosemead Court, Danville, CA, 94506, US

(21) Appl. No.: 10/807,819

(22) Filed: Mar. 24, 2004

(51) Int. Cl. F16B 1/00

(52) U.S. Cl. 411/80.1

(57) ABSTRACT

A wall and ceiling fastening system and method useful for applications such as hanging or securing objects to hollow walls and ceilings is provided. In one embodiment, the fastening system includes a drivable anchor having at least one pivotable section and a pin configured to be inserted into a channel of the anchor. The anchor is driven into a wallboard of the wall or ceiling with a hammer or a suitable tool. As the pin is inserted into the anchor, a lever or rack and pinion action between the pin and the pivotable section causes the pivotable section to pivot towards and come into contact with an interior surface of the wallboard. Depending on the fastening application, the pin can have a suitable head such as a pan screw head, a flat screw head, a round screw head, an oval screw head, a countersunk screw head, a machine screw head, a hook head, an eye hook head, a ring head, a swivel head, a shoulder head, a nut, a bolt head or other suitable head. In addition, the pin can have a ratcheted body, a threaded body, or a ribbed body. In some embodiments, the cross-sectional profile of the anchor is elongated so as to provide a larger supporting surface between the anchor and the wallboard. In addition, the cross-sectional profile of the anchor channel can be elongated so that a wider range of pin body sizes and types can be accommodated. The anchor body may also have one of more stabilizing ribs.

### BACKGROUND OF THE INVENTION

The present invention relates to mounting systems. More particularly, the present invention relates to methods and apparatus for mounting fasteners to hollow walls and ceilings.

Most walls and ceilings of residential and commercial structures are hollow cavity construction. Typically, “drywall”, also known in the trade as gypsum board, is nailed, glued and/or screwed to a suitable frame which includes as wood or metal studs and/or joists, spaced sixteen or twenty-four inches on center, to form these walls. Another less common wall and ceiling material with similar characteristics is plaster. A variety of fastening systems are commercially available for attaching fasteners to these walls to hang or secure objects such as pictures, mirrors and shelving, cabinetry, towel racks, hand rails or any object that requires anchorage at a location in the wall or ceiling other than where a framing member is located. Most fasteners can be divided into several general categories: toggle, expansion and auger fasteners.

One common toggle fastener is the spring-wing toggle bolts in which a pair of toggles is folded together at the end of a screw. The assembly is inserted into a pre-drilled hole in the wall where the toggles are released. Both toggles spring about ninety degrees away from the screw to form a retainer. Disadvantages include the need to pre-drill an oversized hole, difficulty in keeping the toggles from spinning while trying to tighten the screw against the toggles, multiple fastener sizes for multiple screw sizes, and the higher cost associated with manufacturing metal anchors.

Another toggle design is a single toggle fastener in which the middle of the toggle is attached to end of the screw. The toggle is folded against screw and inserted into a pre-drilled hole in the wall. Gravity causes the toggle to be released thereby forming a retainer. Disadvantages include the need to pre-drill an oversized hole, difficulty in keeping the toggle stationary while trying to tighten the screw against the toggle, multiple toggle sizes for multiple screw sizes, and the higher cost associated with manufacturing metal anchors.

Yet another toggle system uses a pair of folding plastic flaps that initially are lying flat against the screw. Upon insertion into a pre-drilled hole in the wall, the tightening of the screw draws the far end of the plastic flaps towards the inside surface of the wall, thereby causing the flaps to begin bending in the middle and eventually form two plastic toggles perpendicular to the screw. Disadvantages of this system include the need for pre-drilling an oversized hole. In addition, if the flaps are improperly drawn toward the inside surface of the wall, the inside surface is crushed thereby weakening the load bearing ability of the wall.

Expansion anchoring systems include alligator anchors which are hollow plastic screws receptacles with split sleeves. When the assembly is inserted into a pre-drilled hole in the wall, the screw is tightened which causes the sleeve to expand along the split. This method is disadvantageous because pre-drilling is needed. In addition, the opening of the split sleeves often crushes the back of the wall thereby reducing the load-bearing capacity of the wall. Often, as increasing torque is placed on the anchor as the screw is driven in, the anchor will often cause the wall to fail, enabling the anchor to begin spinning in place and severely compromising the wall's capacity to grip the anchor securely.

There is also a class of hybrid toggle/expansion fasteners, known as metal expansion anchors, where several narrow metal stripes fold and collapse outwards in a radial pattern as the far end of the anchor is drawn towards the wall. Disadvantages include the need for pre-drilling, and crushing of the inside surface of the wall from the pressure of the narrow metal stripes.

Self-drilling and self-tapping auger-type anchors can also be used as hollow wall fasteners. Unfortunately these auger anchors do not work well in drywall because gypsum board is easily crushed into a powder. Often, the anchor is over-torqued during installation causing the drywall to fail structurally and decompose into a loose powder. Consequently, the wall loses the ability to hold the anchor securely, and the resulting anchorage is weak and detaches easily from the wall, leaving a large unsightly hole where a functional anchor needs to be located.

In sum, the different commercially available fasteners described above have significant disadvantages such as having to select the correctly-sized anchor for the screw and to select the correctly-sized drill bit for the anchor so as to avoid poor anchorage. Other disadvantages include the need for pre-drilling the wall for the anchor, difficulty in tightening properly since over-torquing the anchor or the screw often results in a failure of the wall and an unsightly oversized hole when the anchor is removed in such an over-torqued condition. Some of these fastening systems are also non-removable or difficult to remove without leaving a large unsightly hole in the wall. Hence there is a need for an improved wall and ceiling fastening system that is superior to these fasteners without most of these drawbacks.

### SUMMARY OF THE INVENTION

To achieve the foregoing and in accordance with the present invention, a wall and ceiling fastening system and method is provided. Such a system is useful for applications such as hanging or securing objects to hollow walls or ceilings. In the following discussion, wallboard is used interchangeably to describe a sheet material, such as drywall, suitable for forming both hollow walls and ceilings.

In one embodiment, the fastening system includes a drivable anchor having at least one pivotable section and a pin configured to be inserted into a channel of the anchor. The anchor is driven into the wallboard with a hammer or a suitable tool. As the pin is inserted into the anchor, a lever action between the pin and the pivotable section causes the pivotable section to pivot towards and come into contact with an interior surface of the wallboard.

Depending on the fastening application, the pin can have a suitable head such as a pan screw head, a flat screw head, a round screw head, an oval screw head, a countersunk screw head, a machine screw head, a hook head, an eye hook head, a ring head, a swivel head, a shoulder head, a nut, or a bolt head. In addition, the pin can have a ratcheted body, a threaded body, or a ribbed body.

In some embodiments, the external cross-sectional profile of the anchor is elongated, e.g., oval or rectangular, so as to provide a larger and hence more secure load-bearing surface area between the anchor and the wallboard. In addition, the internal cross-sectional profile of the anchor channel can be elongated, e.g. oval or rectangular, so that a wider range of pin body types and sizes can be accommodated. The anchor body may also have one of more stabilizing fins to enhance rotational stability and reduce the risk of rotational blowout.

Modifications are also possible without departing from the spirit of the invention. For example, instead of lever action, a rack and pinion action between the pin and the pivotable section can be used to cause the pivotable section to pivot towards and come into contact with an interior surface of the wallboard.

Advantages of the fastening system of the present invention include eliminating the need for pre-drilling, reducing the risk of wall blowout resulting from both driving the anchor in and from over-torqued anchors or screws, compatibility with a wider range of screws sizes, lengths and configurations, and ease of removal.

Note that the various features of the present invention described above can be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1C show several views of one embodiment of the fastening system with one pivotable section in accordance with the present invention.

FIGS. 1D and 1E illustrate exemplary pins for the fastening system of FIG. 1A.

FIGS. 2A through 2E illustrate how one embodiment of the fastening system is installed in a wall or ceiling.

FIGS. 3A through 3D illustrate how another embodiment of the fastening system, with multiple pivotable sections, is installed in a wall or ceiling.

FIGS. 4A and 4B are pre-pivoting and post-pivoting views illustrating yet another embodiment of the present invention.

FIGS. 4C and 4D are isometric views of the embodiment of FIG. 4A.

FIGS. 5A-5C are pre-pivoting tip views of three embodiments with two pivotable sections, three pivotable sections, and four pivotable sections, respectively, in accordance with the invention.

FIGS. 6A-6C show yet another embodiment of the fastening system in accordance with the present invention.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

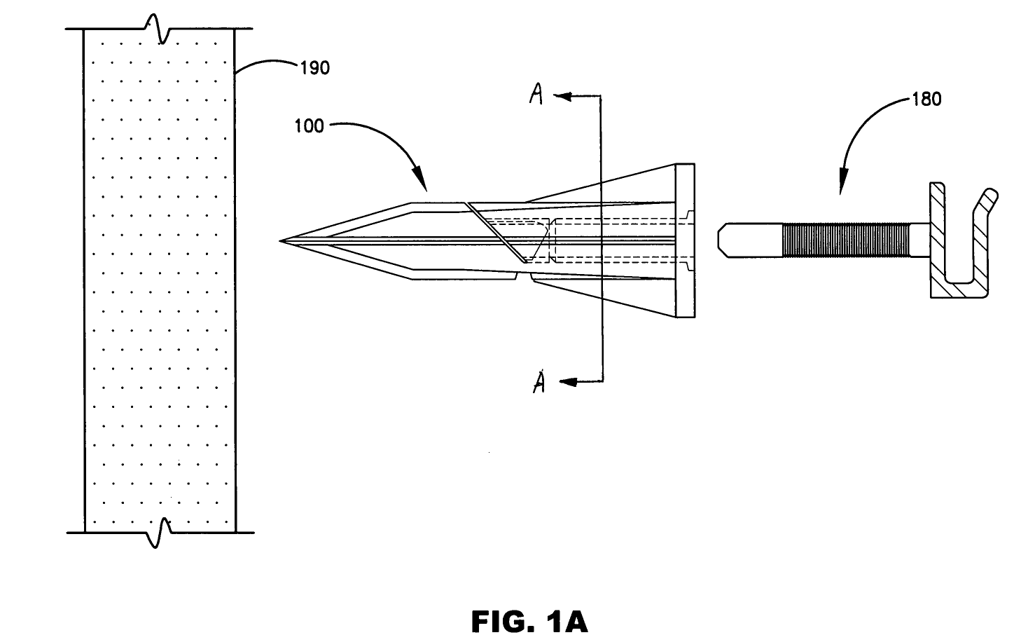

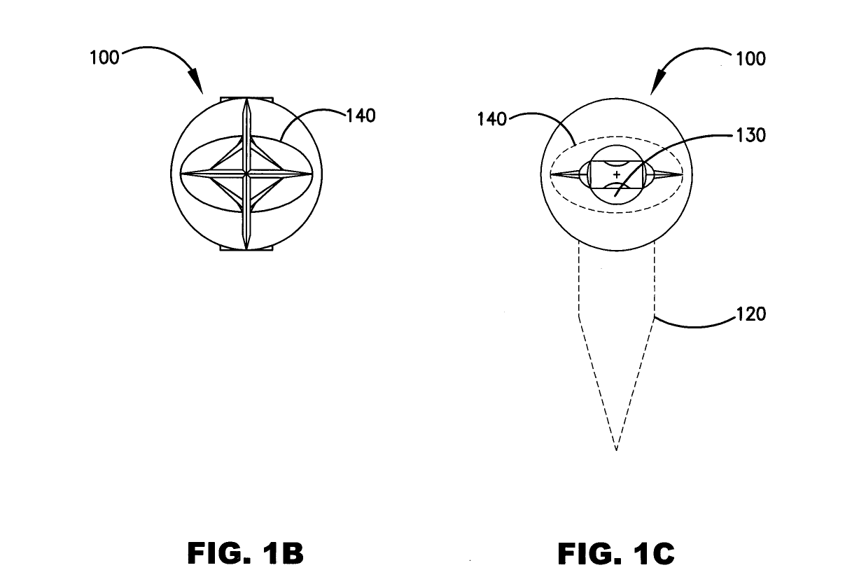

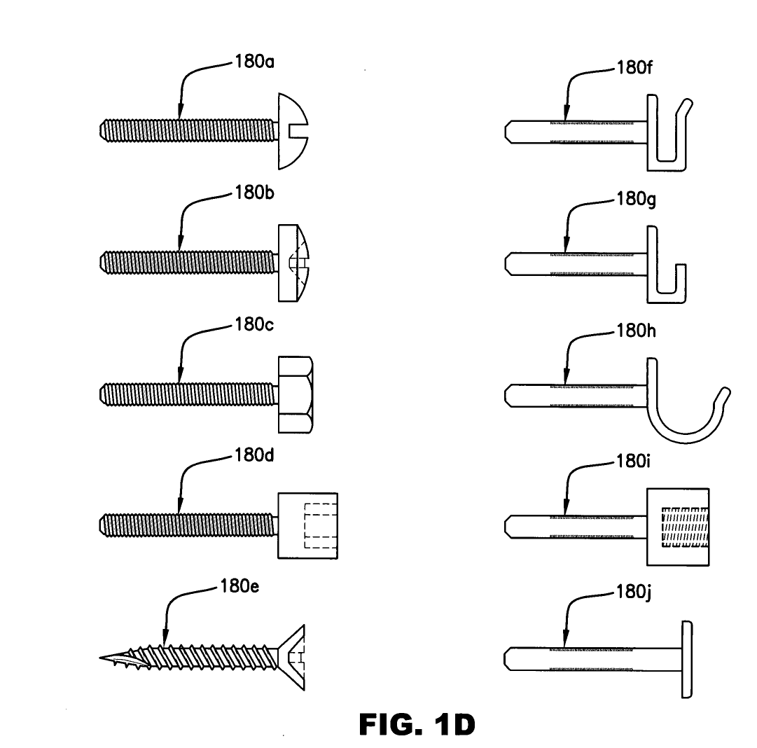

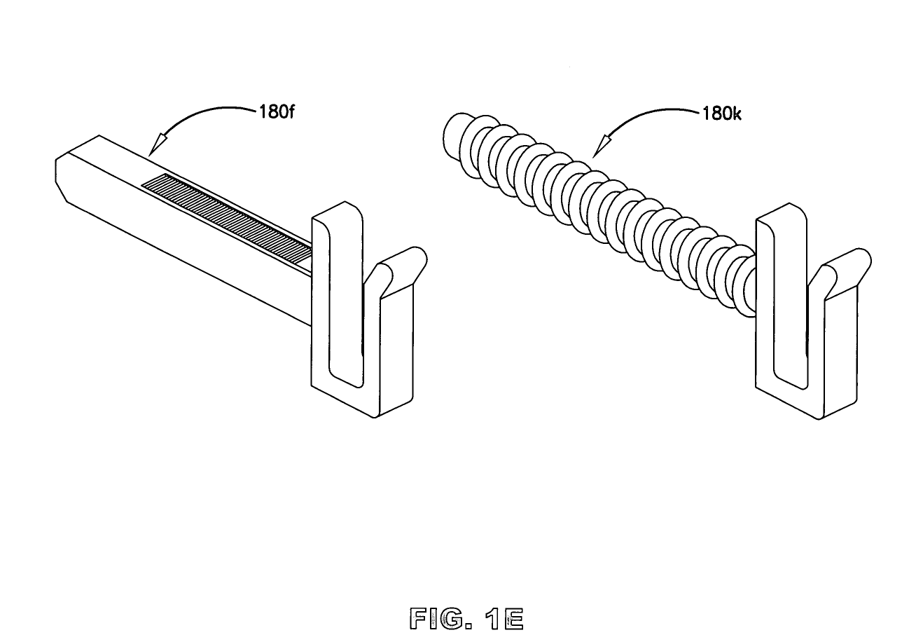

To facilitate discussion, FIGS. 1A-1E, 2A-2E, 3A-3D, 4A-4D, 5A-5C, and 6A-6C illustrate various views and installation stages of the wall and ceiling fastening system and methods of the present invention. In addition, “wallboard” is used interchangeably to describe a sheet material, such as drywall, suitable for forming hollow walls and/or hollow ceilings in accordance with the invention.

FIGS. 1A-1C show several views of one embodiment of an anchor 100 and a pin 180 of the fastening system in accordance with the present invention. In FIG. 1A, anchor 100 and pin 180 are shown prior to installation in wallboard 190. FIGS. 1B and 1C show the tip and head views, respectively, of anchor 100. FIG. 1D show a variety of exemplary heads for pin 180 including a flat driver head pin 180a, a Phillips head pin 180b, a hex bolt head pin 180c, a hex socket head pin 180d, a countersunk wood or drywall screw 180e, three styles of hook head pins 180f, 180g, 180h, a recessed machine screw head pin 180i and a nail type head pin 180j. Other fastener heads known to one skilled in the art are also possible including eye hooks, headless screws, recessed hex screws and lug nuts. FIG. 1E shows isometric views of hook head pins 180f and 180k, with a ratcheting body and a threaded body, respectively.

Depending on the application of the fastening system, pin 180 can include other suitable fastening head designs or configuration, materials, finishes, sizes, metric or standard specification, variety of lengths, known to one skilled in the art. Examples of suitable body designs or configuration for pin 180 include machine thread, wood screw thread, self-tapping thread, course or fine thread, a ribbed body, or a locking or ratcheting mechanism which allows pin 180 to be inserted securely into anchor 100. Other variations, modifications and combinations for pin 180 are also possible. For example, the cross-sectional body profile for pin 180 can be square, rectangular, round, or oval. The ratcheting mechanism may be on one or more sides of pin 180, or substantially around the whole body of pin 180.

Depending on the object(s) being anchored to wall 109, suitable head designs for pin 180 can include pan, flat, round, oval, and countersunk heads, while suitable head configurations for pin 180 can include hook, eye, ring, swivel, shoulder, nut, bolt heads, and any other suitable head designs know to one skilled in the art.

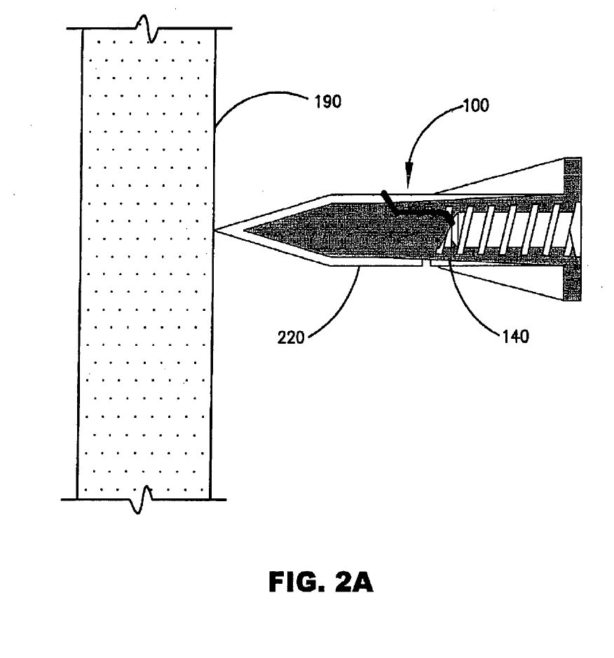

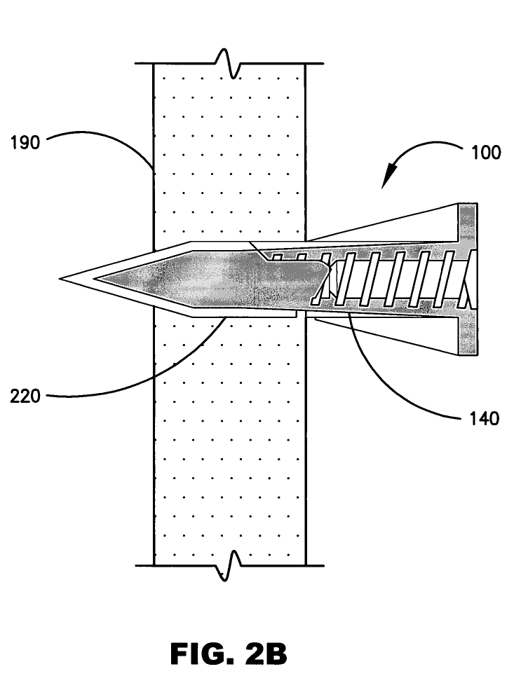

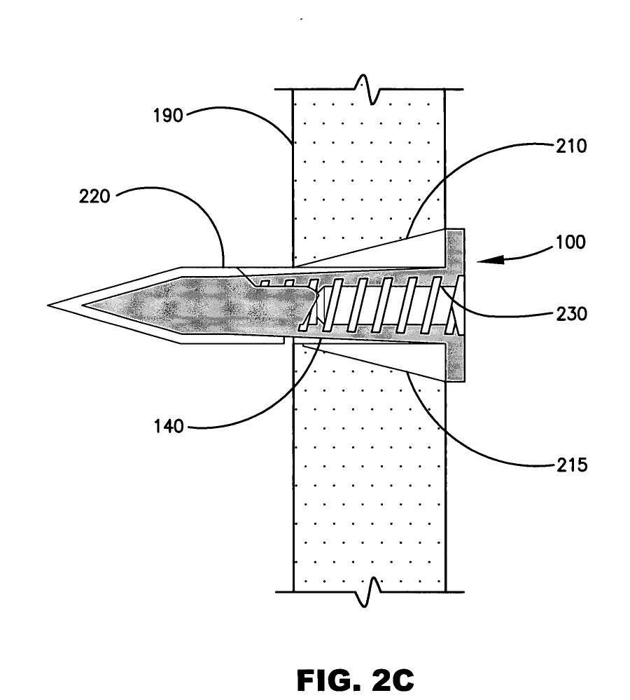

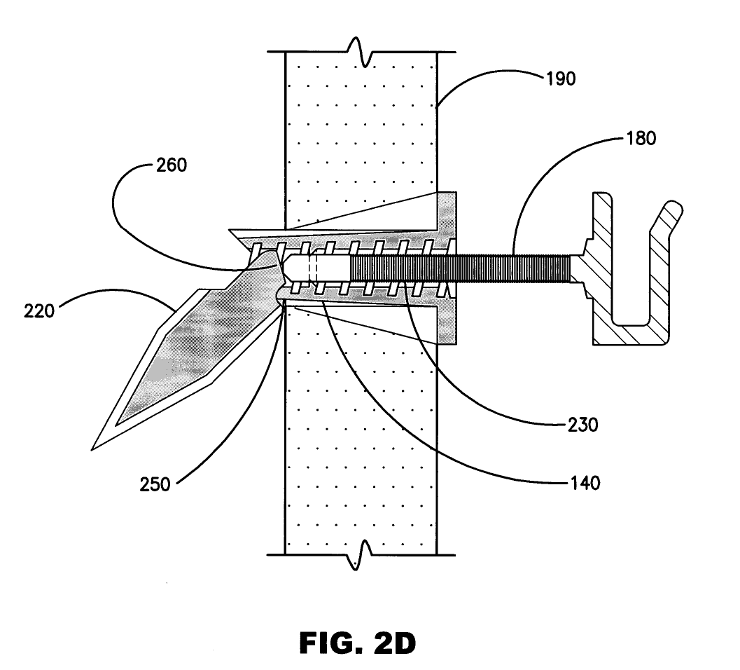

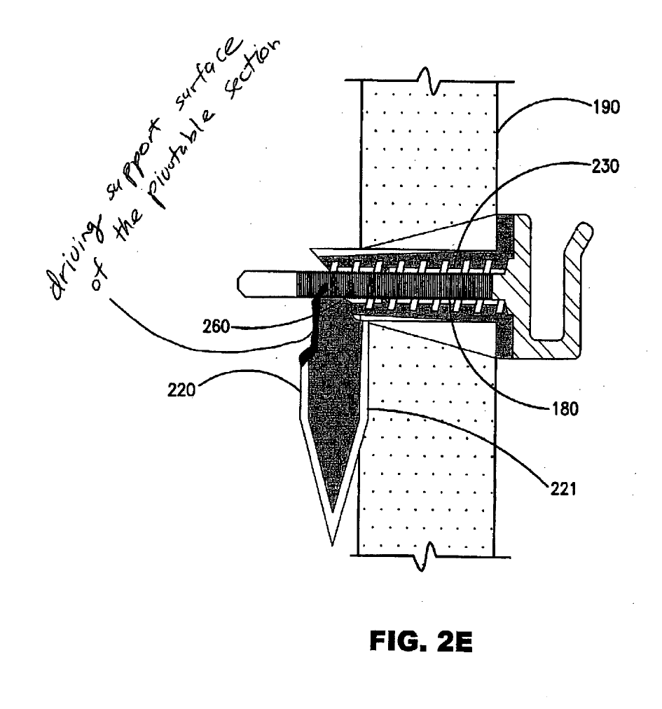

FIGS. 2A through 2E illustrate how one embodiment of fastening system of the present invention is installed in wallboard 190 of a hollow wall or ceiling. Referring first to FIGS. 2A-2C, drivable anchor 100 is driven into wallboard 190 with a hammer or any suitable tool, without the need for pre-drilling a hole in wallboard 190. Anchor 100 includes two main sections; a pivotable section 220 and a wallboard support section 140. Pivotable section 220 and wallboard support section 140 are aligned and integrated in a manner so that the driving force applied to wallboard support section 140 are transferred to pivotable section 220 without causing pivotable section 220 to prematurely pivot away from wall support section 140. In addition, as shown in FIG. 2C, a portion of pivotable section 220 is initially located inside and supported by channel 230 of wallboard support section 140, thereby providing additional anchor rigidity, strength and stability while driving anchor 100 into wallboard 190.

In some embodiments, anchor 100 can be driven into wallboard 190 without the need for pre-drilling a hole, thereby simplifying and speeding up the installation process. Ideally, pivotable section 220 has a pointed self-centering tip and sharp edges tapering towards wallboard support section 140. The sharp edges of pivotable section 220 may also be stepped and/or serrated for cutting cleanly through wallboard 190.

In some embodiments, as shown in FIGS. 1B and 1C, the cross-sectional external profile of wallboard support section 140 is elongated so as to advantageously provide a wider support area in wallboard 190, thereby spreading the compression forces exerted by an object to be supported by the fastening system of the present invention. Examples of elongated profiles include oval, rectangular, diamond, elliptical, flattened or other similar profiles.

FIG. 1C also shows another advantageous feature of anchor 100 in which the cross-sectional profile of channel 130 may be elongated, e.g., substantially oval or rectangular. Such a channel profile, especially in combination with a suitable elastic anchor material, can accommodate an extended range of suitable profiles and sizes for the body of pin 180, including square or rectangular pins and a wider range of screw diameters.

As shown in FIG. 2C, additional stability can also be provided to anchor 100 by optional fins 210 and 215 which resist rotational forces when pin 180 is inserted into anchor 100. This stability feature is especially useful in embodiments where pin 180 is screwed into anchor 100.

FIGS. 2D and 2E illustrate another advantageous feature of the present invention, in which the insertion of pin 180 into anchor 100 also secures anchor 100 to wallboard 190. FIG. 2D shows the tip end of pin 180 pushing against a lever 260 of pivotable section 220, causing pivotable section 220 to pivot at a pivot point 250, and begins to deploy towards the interior surface of wallboard 190. In FIG. 2E, as the tip end of pin 180 pushes past lever 260, pivotable section 220 completes folding against the interior surface of wallboard 190. In this embodiment, lever 260 includes a ramped surface which enables pin 180 to deploy pivotable section 220. Accordingly, lever 260 transfers a moment-arm force exerted by pin 180 from the end of lever 260, around pivot point 250, to pivotable section 220 which in turn exerts a secure clamping force against the interior surface of wallboard 190. Other mechanical systems known to one skilled in the art can also be used in place of the ramped surface, including a cammed surface or some other suitable flat and/or curved surface.

Pivot point 250 can be accomplished by several techniques including a reduction in material thickness or using a pliable material at pivot point 250 to enable pivotable section 220 to bend at pivot point 250, or a hinge with a pivoting pin, cut or shaped hollow space with the material at pivot point 250 or any other suitable means to enable pivotable section 220 to pivot toward wallboard 190. In some embodiments, wallboard tensioning face 221 of pivotable section 220 compresses into the interior surface of wallboard 190 for additional stability.

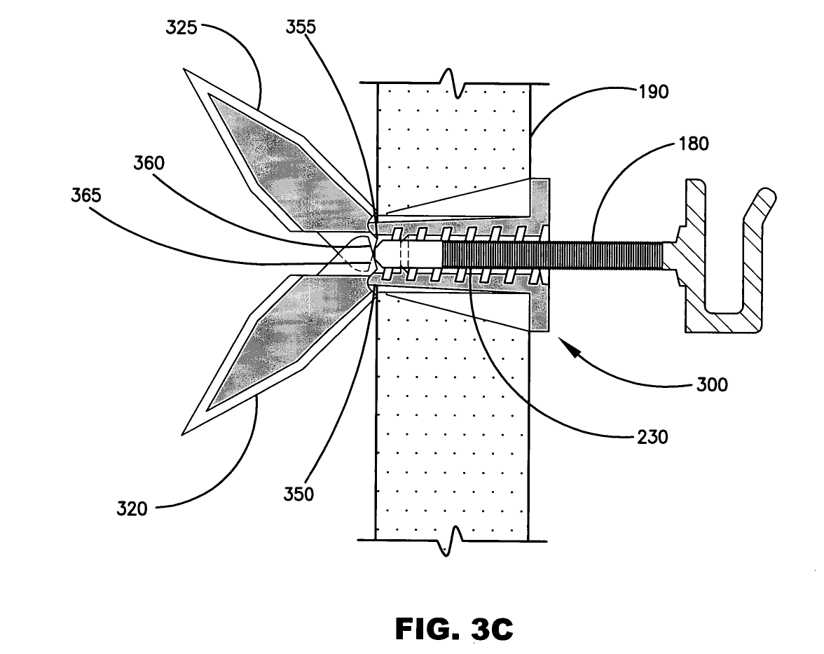

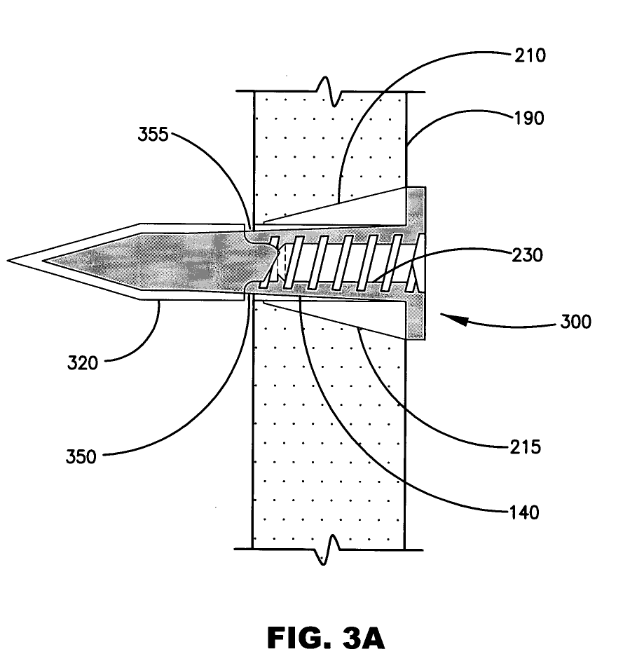

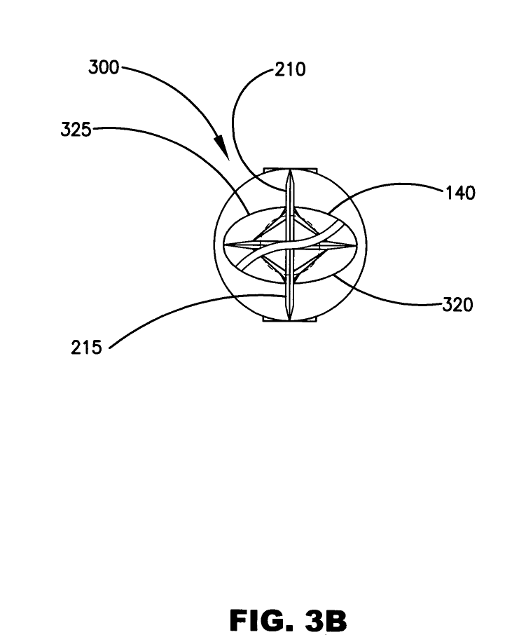

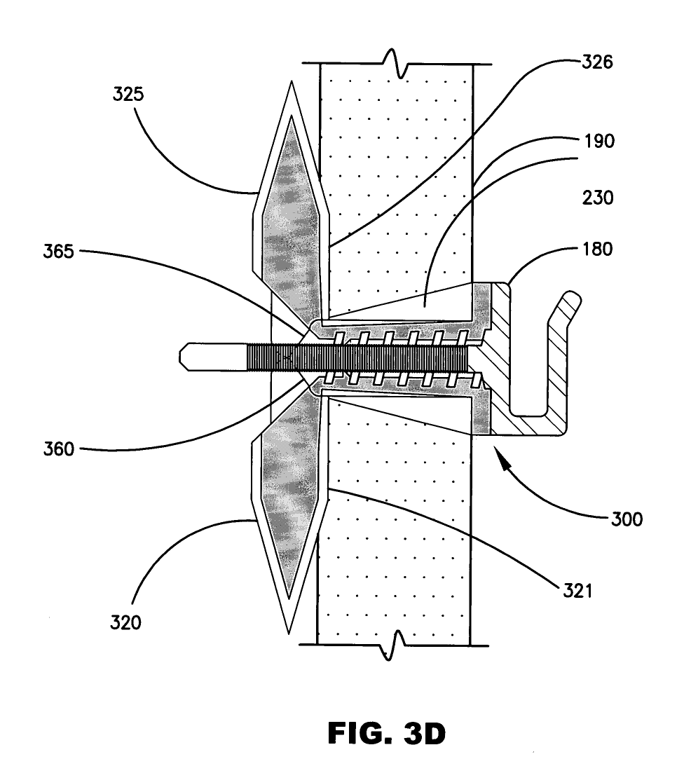

FIGS. 3A-3D illustrate another embodiment of the present invention wherein drivable anchor 300 has two or more pivotable sections. The side and tip views of FIGS. 3A and 3B, respectively, show one embodiment with two pivotable sections 320 and 325 which are configured to pivot away from each other and compress against interior surface of wallboard 190.

FIG. 3C shows the tip end of pin 180 pushing against opposing levers 360 & 365 of pivotable sections 320 & 325, causing pivotable sections 320 & 325 to pivot away from each other at pivot points 350 & 355 and begin to fold towards the interior surface of wallboard 190. In FIG. 3D, as the tip end of pin 180 pushes past cams 360 & 365, pivotable sections 320 & 325 complete folding against the interior surface of wallboard 190. In some embodiments, wallboard tensioning faces 321 & 326 of pivotable sections 320 & 325, respectively, both compress into the interior surface of wallboard 190 for additional stability as shown in FIG. 3D.

As discussed above, many variations of pin 180 are possible. For example the shank or body of pin 180 may be threaded, serrated, or ratcheted. In addition, the shank of pin 180 may be straight or tapered. Pin 180 may be solid or hollow and can be made from a variety of plastics, metals or any suitable materials known to one skilled in the art, including nylon, polycarbonate, acrylic and aluminum.

In some embodiments, a secondary pin is pre-inserted into anchor channel 230 before primary pin 180 is inserted into channel 230. This permitted the use of a shorter primary pin 180 such as a short machine screw. In these embodiments, as primary pin 180 is driven into channel 230, primary pin 180 pushes on the secondary pin which in turn pushes against lever 260 or levers 360 & 365.

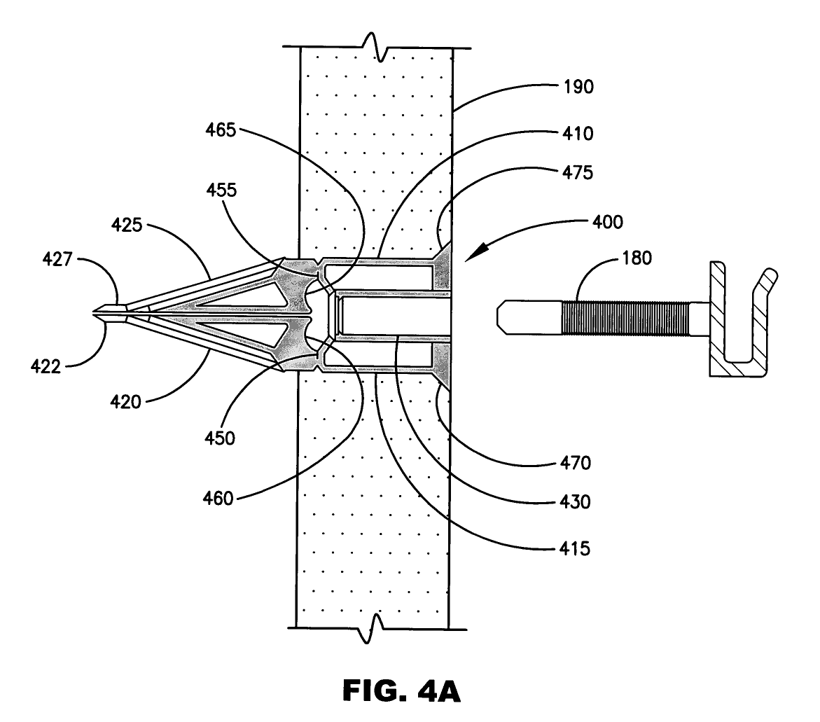

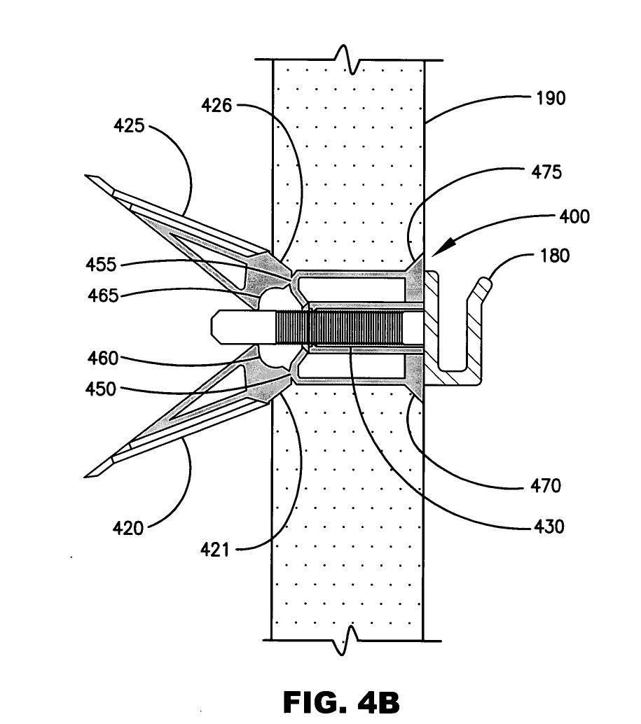

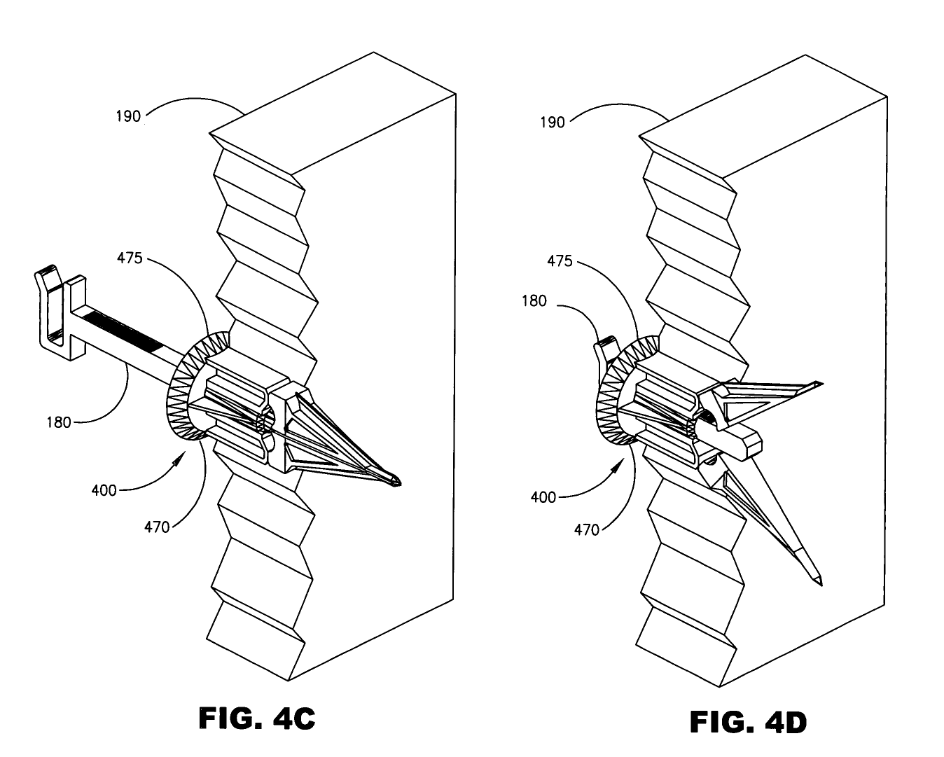

FIGS. 4A and 4B are pre-pivoting and post-pivoting side views illustrating yet another embodiment of the present invention. FIGS. 4C and 4D are isometric views of FIGS. 4A and 4B, respectively. Anchor 400 includes chamfered edges 470, 475, stabilizing fins 410, 415, a channel 430 for securing pin 180, levers 460, 465, pivot points 450, 455, pivotable sections 420, 425 with pointed tips 422, 427. Drivable anchor 400 can be driven into wallboard 190 using a suitable tool, such as a hammer, without the need for pre-drilling a hole in wallboard 190. In this embodiment as shown in FIG. 4B, when fully deployed, pivotable sections 420, 425 pivot away from pin 180 and securely engage the interior surface of wallboard 190. Anchor 400 is now securely fastened to wallboard 190 by compression forces between chamfered edges 470, 475 and flat edges 421, 426, respectively, and provides a secure anchorage point for the wall or ceiling. As shown in FIGS. 4C and 4D, chamfered edges 470, 475 can also be “ribbed” to increase the clamping surface area and also to improve rotational stability.

In this embodiment, stabilizer fins 410, 415 keep anchor 400 from rotating especially in applications where pin 180 has a threaded body, thereby reducing the risk of rotation blowout. In addition, by angling pivotable sections 420, 425 to wallboard 190, anchor 400 can be use with a wider range of wallboard thicknesses without increasing the risk of blowouts.

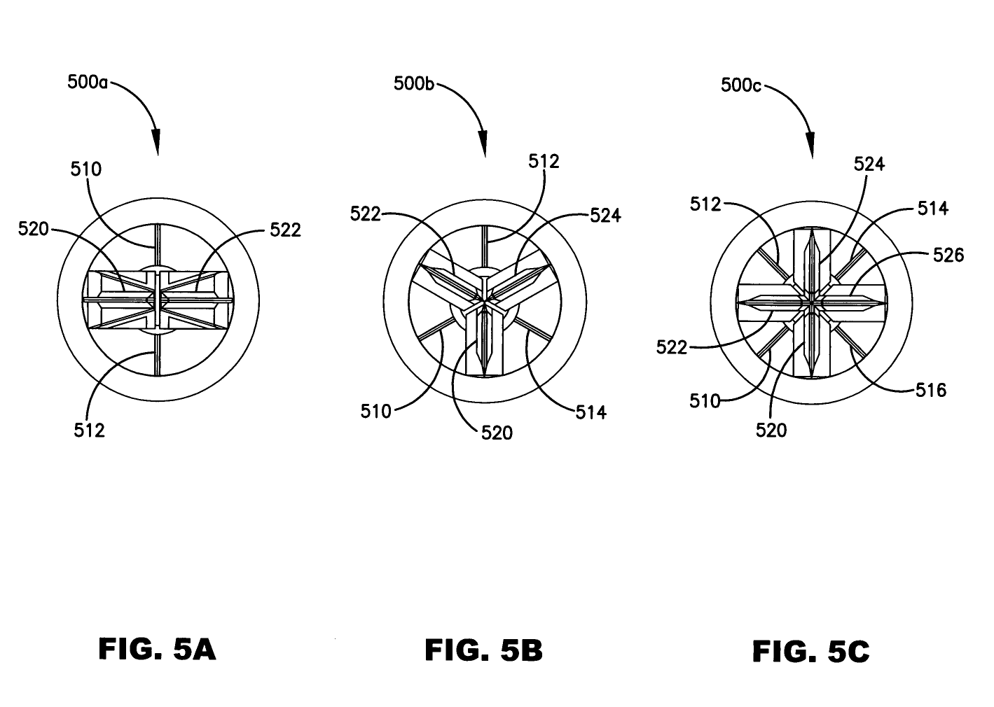

FIGS. 5A-5C are pre-pivoting tip views of three embodiments in accordance with the invention. In FIG. 5A, anchor 500a includes two pivotable sections 520 & 522, and two stabilizing fins 510 & 512. FIG. 5B shows anchor 500b with three pivotable sections 520, 522 & 524, and three stabilizing fins 510, 512 & 514. As shown in FIG. 5C, anchor 500c has four pivotable sections 520, 522, 524 & 526 and four stabilizing fins 510, 512, 514 & 516.

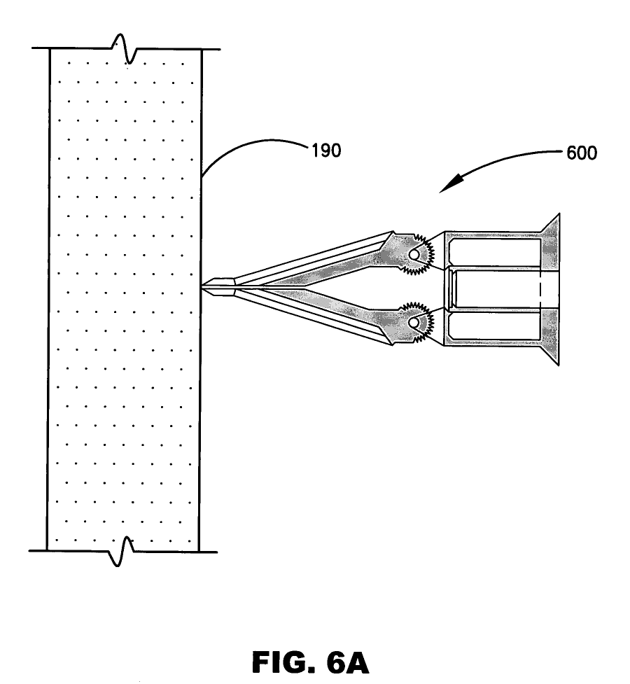

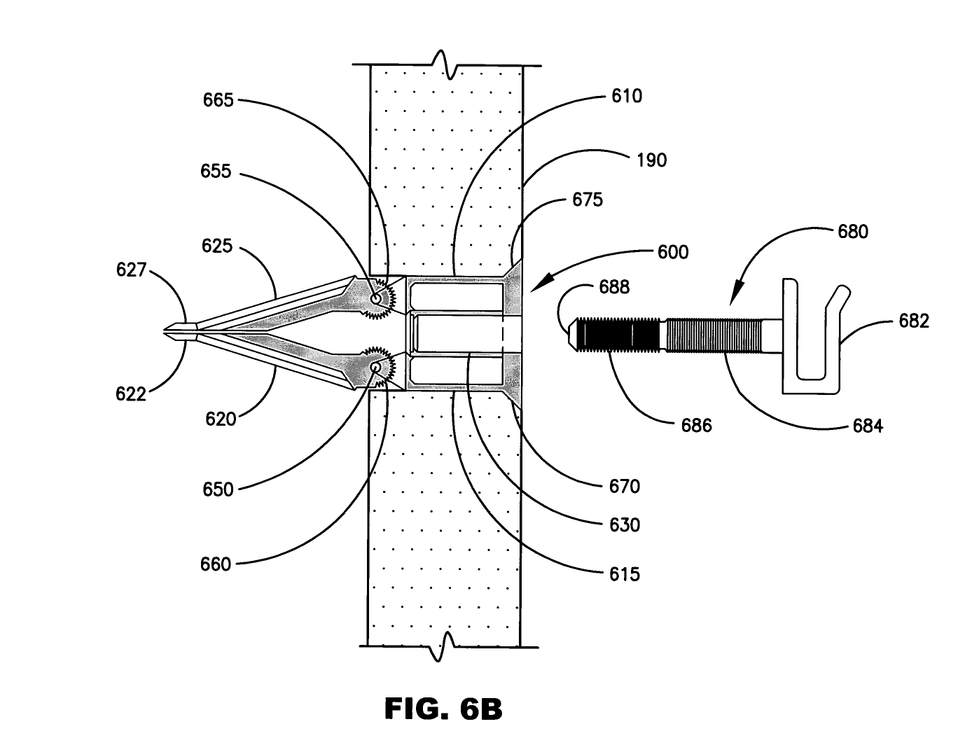

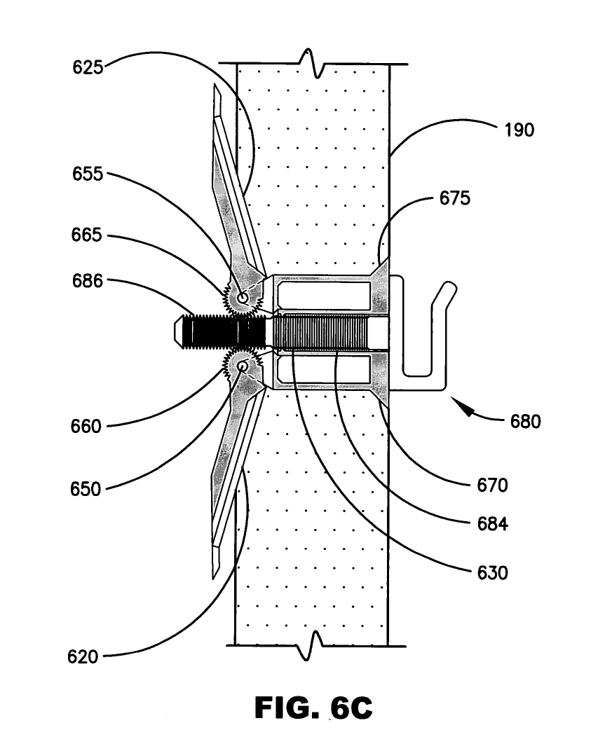

Referring now to FIG. 6A-6C which show yet another embodiment of the invention, instead of a lever design, anchor 600 employs a rack and pinion design for clamping wallboard 190. Accordingly, anchor 600 includes chamfered edges 670, 675, stabilizing fins 610, 615, a ratcheted channel 630 for securing ratcheted pin 680, pivot points 650, 655, and pivotable sections 620, 625 with pointed tips 622, 627 and toothed pinions 660, 665. As shown in FIG. 6B, pin 680 includes a toothed rack 686 which is configured to engage toothed pinions 660, 665 of pivotable sections 620, 625 respectively.

In FIG. 6C, after drivable anchor 600 is driven into wallboard 190, as ratcheted section 684 of pin 680 engages the corresponding ratchets of channel 630, and locks pin 680 with every advancement of pin 680 to the next ratcheted section of channel 630, toothed rack 686 also engages the respective toothed pinions 660, 665 of pivotable sections 620, 625, and causes pivotable sections 620, 625 to begin pivoting toward the internal surface of wallboard 190. Eventually wallboard 190 is compressed tightly between pivotable sections 620, 625 and chamfered edges 670, 675, and anchor 600 becomes securely fastened to wallboard 190.

Since the final deployed angle between pivotable sections 120, 220, 320, 325, 420, 425, 520, 522, 524, 526, 620, 625 and the respective anchors 100, 300, 400, 500a, 500b, 500c, 600 can be pre-determined by the design of the anchor/pin pivoting mechanism, blowouts of wallboard 180 from over-compressing is greatly reduced. In addition, by controlling the pivotable section angle, it is also possible to use anchors 100, 300, 400, 500a, 500b, 500c, 600 in an existing blown-out hole in wallboard 190 which resulted from a failure of an inferior anchor of the prior art.

As discussed above, the various embodiments of drivable anchors 100, 300, 400, 500a, 500b, 500c, 600 can have a substantially pointed tip end which tapers back and is chamfered to the main body of anchors 100, 300, 400, 500a, 500b, 500c, 600, and in combination with a suitable rigid anchor material, eliminates the need for pre-drilling a hole in wallboard 190. In addition, the self-centering pointed tips and sharp edges of pivotable sections 120, 220, 320, 325, 420, 425, 520, 522, 524, 526, 620, 625 enable drivable anchors 100, 300, 400, 500a, 500b, 500c, 600 to cut cleanly through wallboard 190, while the tapered and chamfered profile of drivable anchors 100, 300, 400, 500a, 500b, 500c, 600 clears wallboard debris away from the anchor body, thereby avoiding blowouts in wallboard 190.

It is possible to use an anchor material rigid enough so that drivable anchors 100, 300, 400, 500a, 500b, 500c, 600 can also be driven into the frame supports of wallboard 190, thereby permitting anchors 100, 300, 400, 500a, 500b, 500c, 600 to be used in both the hollow and non-hollow sections of wallboard 190. Since the fully deployed pivot angle of pivotable sections 120, 220, 320, 325, 420, 425, 520, 522, 524, 526, 620, 625 can be predetermined by the design of anchor and pin combination, it is also possible to avoid over-compression and the resulting blowouts of wallboard 190 during installation of anchors 100, 300, 400, 500a, 500b, 500c, 600.

Other embodiments and modifications are also possible without departing from the spirit of the invention. For example, by changing the location of pivot points 250, 350, 355, 450, 455, 650, 655, instead of initially pivoting away from each other, pivotable sections 220, 320, 325, 420, 425, 620, 625 can be configured to initially pivot towards each other, cross over each other, and then continue pivoting away from each other and towards the interior surface of wallboard 190, thereby using the opposing non-cutting sides of the pivotal sections 220, 320, 325, 420, 425, 620, 625 to compress against wallboard 190. The pivoting action of pivotable sections 120, 220, 320, 325, 420, 425, 520, 522, 524, 526, 620, 625 can be accomplished by several mechanical means known to one skilled in the art.

In sum, advantages of the fastening system of the present invention include no need for pre-drilling, reduced risk of wallboard blowout from over-torqued anchors or screws, compatibility with a wider range of screws sizes, lengths and configurations, ease of removal, self-centering tip, elongated load-bearing anchor body, superior wall clamping surfaces, greater load-bearing capability from increased anchor/wallboard contact surface area, and stabilizer fins which are resistant to rotational blowout.

While this invention has been described in terms of several preferred embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

1. A method for attaching a drivable anchor to a wallboard, the anchor useful in association with a pin, the method comprising:
driving the anchor into the wallboard without a need for pre-drilling the wallboard, the anchor having a pivotable section and a wallboard support section, and wherein the pivotable section is supported by the wallboard support section while driving the anchor into the wallboard; and
inserting the pin into a channel of the wallboard support section of the anchor, thereby causing the pivotable section of the anchor to pivot and come into contact an interior surface of the wallboard.

2. The method of claim 1, wherein a lever action between the pin and the pivotable section causes the pivotable section to pivot.

3. The method of claim 1, wherein a rack and pinion action between the pin and the pivotable section causes the pivotable section to pivot.

4. The method of claim 1, wherein the pivotable section pivots to a predetermined position relative to the wallboard.

5. The method of claim 1, wherein the pin has one of a pan screw head, a flat screw head, a round screw head, an oval screw head, a countersunk screw head, a machine screw head, a hook head, an eye hook head, a ring head, a swivel head, a shoulder head, a nut, and a bolt head.

6. The method of claim 1, wherein the pin has one of a ratcheted body, a threaded body, and a ribbed body.

7. The method of claim 1, wherein an external cross-sectional profile of the anchor is elongated so as to provide a larger load-bearing surface for the wallboard, the cross-sectional profile being perpendicular to a driving axis of the anchor.

8. The method of claim 1, wherein an internal cross-sectional profile of the channel is elongated so as to accommodate a range of pin sizes and types, the cross-sectional profile being perpendicular to a driving axis of the anchor.

9. The method of claim 1, wherein the anchor includes at least one stabilizing fin.

10. A fastener useful in association with a wallboard, comprising:
a drivable anchor having at least one pivotable section and a wallboard support section, and wherein the pivotable section is configured to be supported by the wallboard support section when the anchor is driven into the wallboard, the anchor configured to be driven into the wallboard without a need for pre-drilling the wallboard; and
a pin configured to be inserted into a channel of the wallboard support sections of the anchor so that the insertion of the pin into the wallboard support section causes the pivotable section of the anchor to pivot and come into contact an interior surface of the wallboard.

11. The fastener of claim 10, wherein the anchor and the pin are configured so that a lever action between the pin and the pivotable section will cause the pivotable section to pivot.

12. The fastener of claim 10, wherein the anchor and the pin are configured so that a rack and pinion action between the pin and the pivotable section will cause the pivotable section to pivot.

13. The fastener of claim 10, wherein the pivotable section is configured to be pivoted to a predetermined position relative to the wallboard.

14. The fastener of claim 10, wherein the pin has one of a pan screw head, a flat screw head, a round screw head, an oval screw head, a countersunk screw head, a machine screw head, a hook head, an eye hook head, a ring head, a swivel head, a shoulder head, a nut, and a bolt head.

15. The fastener of claim 10, wherein the pin has one of a ratcheted body, a threaded body, and a ribbed body.

16. The fastener of claim 10, wherein an external cross-sectional profile of the anchor is elongated so as to provide a larger load-bearing surface for the wallboard, the cross-sectional profile being perpendicular to a driving axis of the anchor.

17. The fastener of claim 10, wherein an internal cross-sectional profile of the channel is elongated so as to accommodate a range of pin sizes and types, the cross-sectional profile being perpendicular to a driving axis of the anchor.

18. The fastener of claim 10, wherein the anchor includes at least one stabilizing fin.

19. A drivable anchor, useful in association with a wallboard and a pin, the anchor configured to be driven into the wallboard without a need for pre-drilling the wallboard, the anchor comprising:
at least one pivotable section; and
a wallboard support section, and wherein the pivotable section is configured to be supported by the wallboard support section when the anchor is driven into the wallboard, the pivotable section configured so that an insertion of the pin into a channel of the wallboard support section of the anchor causes the pivotable section of the anchor to pivot and come into contact an interior surface of the wallboard.

20. The anchor of claim 19, wherein the anchor is configured so that a lever action between the pin and the pivotable section will cause the pivotable section to pivot.

21. The anchor of claim 19, wherein the anchor is configured so that a rack and pinion action between the pin and the pivotable section will cause the pivotable section to pivot.

22. The anchor of claim 19, wherein the pivotable section is configured to be pivoted to a predetermined position relative to the wallboard.

23. The anchor of claim 19, wherein the pin has one of a pan screw head, a flat screw head, a round screw head, an oval screw head, a countersunk screw head, a machine screw head, a hook head, an eye hook head, a ring head, a swivel head, a shoulder head, a nut, and a bolt head.

24. The anchor of claim 19, wherein the pin has one of a ratcheted body, a threaded body, and a ribbed body.

25. The anchor of claim 19, wherein an external cross-sectional profile of the anchor is elongated so as to provide a larger load-bearing surface for the wallboard, the cross-sectional profile being perpendicular to a driving axis of the anchor.

26. The anchor of claim 19, wherein an internal cross-sectional profile of the channel is elongated so as to accommodate a range of pin sizes and types, the cross-sectional profile being perpendicular to a driving axis of the anchor.

27. The anchor of claim 19, wherein the anchor further comprises at least one stabilizing fin.

28. (canceled)

29. (canceled)

30. (canceled)

31. (canceled)

32. An anchor useful in association with a wallboard and a pin, the anchor comprising an anchor having at least one pivotable section, the pivotable section configured so that a geared rack and pinion action between the pin and the anchor causes the pivotable section to pivot and come into contact an interior surface of the wallboard as the pin is inserted into a channel of the anchor.

33. The method of claim 1 wherein the wallboard support section has a recess for supporting the pivotable section.

34. The fastener of claim 10 wherein the wallboard support section has a recess for supporting the pivotable section.

35. The anchor of claim 19 wherein the wallboard support section has a recess for supporting the pivotable section.
